(19) United States
(12) Patent Application Publication
(10) Pub. No.: US 2007/0277455 A1
(43) Pub. Date: Dec. 6, 2007

(54) Vinyl window with flush trim

(76) Inventors: Sean T. Flanigan, Falmouth, ME (US); Ronald Frederick Edger, Bolton (CA)

Correspondence Address: BOHAN, MATHERS & ASSOCIATES, LLC, PO BOX 17707, PORTLAND, ME, 04112-8707, US

(21) Appl. No.: 11/442,791

(22) Filed: May 30, 2006

(51) Int. Cl. E06B 1/04

(52) U.S. Cl. 52/206

(57) ABSTRACT

Trim panels for vinyl double-hung window with raised screen track that provide the traditional look of a wood window. The trim panels are adjacent and abut the raised screen track, thereby eliminating the typical “valley” between the screen track and the trim panels of conventional vinyl windows.

### BACKGROUND INFORMATION

1. Field of the Invention

The invention relates to the field of windows and, more particularly, to vinyl windows having a track for a bug screen. More particularly yet, the invention relates to trim panels for such windows.

2. Description of the Prior Art

The traditional wood window generally has a flat trim or window casing on the outside wall of the structure in which the window is installed. With these windows, the casing or trim attaches directly to the window frame and the profile of the trim is raised relative to the window frame. Storm windows were set inside the exterior trim or casing of the wood window, and were attached to the frame of the window itself. Older traditional wood windows did not include a bug screen integrated into the window frame. In recent decades, the bug screen was often part of an aluminum storm window unit that was attached to the window trim on the outside wall of the structure. This aluminum unit had a relatively flat profile that was unobtrusive with regard to the flat profile of the window casing.

Vinyl windows have gained steadily in popularity over the years because of their durability and low maintenance. The conventional vinyl window typically integrates a bug screen into the window frame. A drawback to this conventional vinyl window is that the bug screen is maintained in a screen lip or track that is raised relative to the surrounding surface of the window trim. Furthermore, the window trim, which has a raised profile relative to the window frame, is attached to the outer edge of the window frame. As a result, a pronounced depression or “valley” is created between the screen track and the window trim. This “valley” is a deviation from the traditional look of windows and is deemed unattractive by many.

What is needed, therefore, is a window unit that appears to have a flat profile on the outside wall, between the screen track and the window trim.

### BRIEF SUMMARY OF THE INVENTION

The present invention is a vinyl or other plastic window unit that provides the traditional look of a wood window unit, with a valleyless transition between the screen track and the window trim. The window unit includes a bug screen in a screen track on the outside face of the window frame. The screen track is offset or raised, relative to the plane of the outside face. Window trim panels include jamb trim panels, a header trim panel, and a sill trim panel. Each of these panels attaches to the window frame, such that the trim panel closely abuts the screen track, thereby forming a transition from window frame to trim panel that appears valleyless, that is, without a visually noticeable depression between the outer edge of the screen track and the adjacent edge of the trim panel. On a window unit mounted in a conventional stud wall, the trim panels are raised in profile relative to the outside face of the window frame and extend away from the window frame along the outside wall in a flat profile. On a window unit installed in a recessed wall opening, such as a thick brick or stone wall, the window trim attaches to the window frame as described above, but the trim panels are curved and exend only to the walls of the recessed opening.

### BRIEF DESCRIPTION OF THE DRAWINGS

The present invention is described with reference to the accompanying drawings. In the drawings, like reference numbers indicate identical or functionally similar elements. The drawings are not necessarily to scale.

FIG. 1 is a front elevational view of the window unit according to the invention.

FIG. 2A is a top-down view of the window unit of FIG. 1, showing the profile of the window trim.

FIG. 2B is a top-down view of the conventional window unit, showing the profile of the conventional window trim. (Prior Art)

FIG. 3 is a cross-sectional view of the window unit according to the invention, showing the structural features of the window frame and jamb trim panel.

FIG. 4 is a front elevational view of the window showing multiple window units.

FIG. 5 is a cross-sectional view of a window unit according to the invention, showing a decorative profile that is particularly suitable for use with a window unit installed in a structure with a brick wall.

FIG. 6 is a cross-sectional view of the window shown in FIG. 5, showing in detail the structural features of the window frame and jamb trim panel.

### DETAILED DESCRIPTION OF THE INVENTION

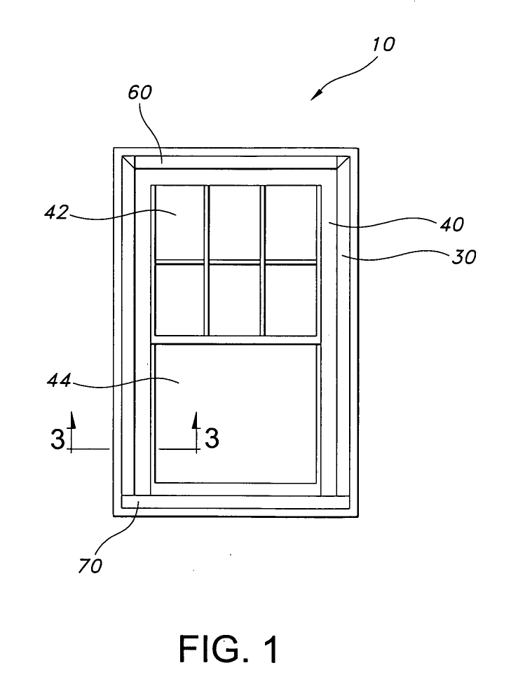

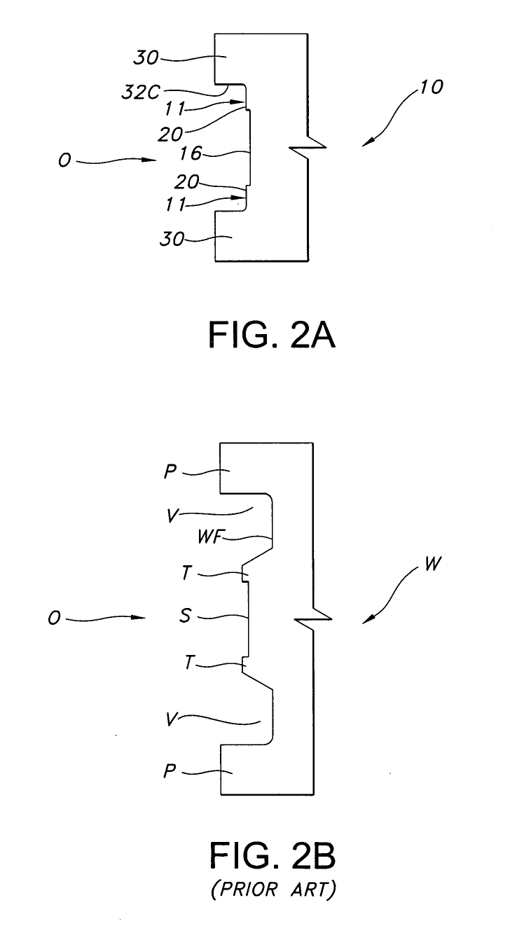

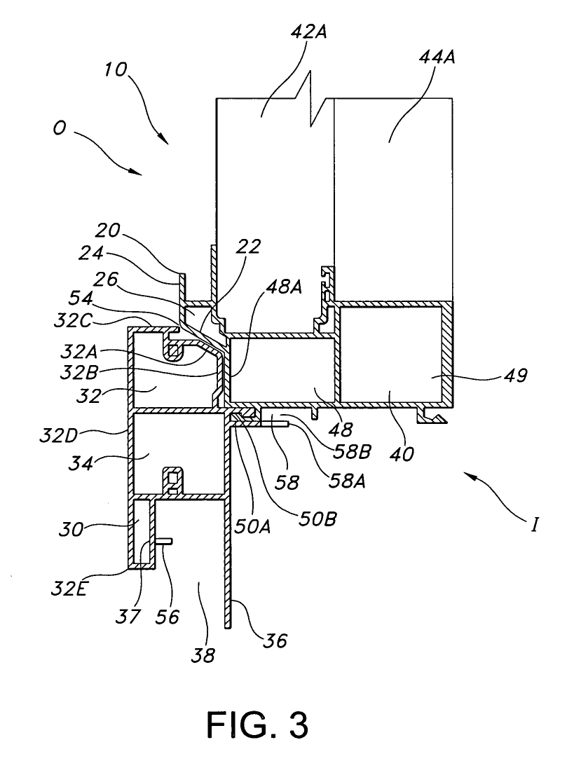

FIG. 1 is a front elevational view of a window unit 10 according to the invention. As viewed from the outside, the window unit 10 comprises a double-hung window frame 40, with a first window sash 42, a second window sash 44, a screen track assembly 20 (shown in FIGS. 2A and 3), a jamb trim panel 30, a header trim panel 60 and a sill trim panel 70. The panels 30, 60, and 70 are generally connected to each other to form a frame and then applied to the window frame 40.

FIG. 2A is a schematically drawn partial top-down view showing only the schematic outlines of the outside contour of the window unit 10, including the raised screen track assembly 20 and the jamb trim panel 30. A bug screen 16 is held in the screen track assembly 20. The jamb trim panel 30 is assembled on the window unit 10, attached to the window frame 40 and adjacent and abutting the screen track assembly 20. The outer face of the jamb trim panel 30 has a first vertical edge 32C, that is offset relative to the face of the screen 16. This jamb trim panel 30 is flush against the part of the window that is visible from the outside, that is, the screen track assembly 20, and provides a look that is consistent with that of traditional wood framed windows.

FIG. 2B (Prior Art) is a schematically drawn partial top-down view showing the profile of a traditional vinyl-frame window unit W that has a jamb trim panel P and a bug screen S held in a screen track T. The screen track T is in a plane that is offset or raised relative to the plane of the outside face of the window frame WF. As shown, a valley V is formed between the screen S and the jamb trim panel P. This profile with the valley V is typical for traditional vinyl-framed window units when jamb trim panels are used.

FIG. 3 is a cross-sectional view of the window unit 10 according to the invention, the cross-sectional cut being somewhere between the header trim panel 60 and the sill trim panel 70. An outside wall face O and an inside wall face I of the wall in which the window 10 is installed are indicated for orientation purposes. The window frame 40 has an outside face 11, that is defined by the plane of the window frame, without the screen track assembly 20. A first window sash channel 42A and a second window sash channel 44A provide channels to retain the respective first and second window sashes 42 and 44. A first box channel 48 and a second box channel 49 provide channels for receiving the first window sash 42 and the second window sash 44, respectively, and also provide rigidity for the window frame 40. Mating J-channel connectors 50A and 50B are provided as shown on the jamb trim panel 30 and the window frame 40 for locking the two components together. The screen track assembly 20 has an offset track profile 22 that is offset or raised toward the outside wall face O, relative to the plane of the outside face 11 of the window frame 40, and a flat track profile 24 that extends parallel to the outside face 11. In the embodiment shown, the offset track profile 22 is shown as a sloping profile; it is understood, however, that this offset may be oriented perpendicular to the plane of the window frame 40. Also shown in this embodiment is a screen box channel 26 that imparts structural strength and rigidity to the screen track assembly 20.

The jamb trim panel 30 attaches to the window frame 40 so as to create a valleyless trim. The description “valleyless” is used to refer to a trim front on a window frame that does not have a valley or depression between the raised screen track 20 and the jamb trim panel 30. In the following description, the terms “proximal” and “distal” are relative to the window frame 40. The jamb trim panel 30 includes a first channel 32 that is proximal to the window frame 40, bounded on one side with the first vertical edge 32C, an outer trim extension panel 37 distal to the window frame and bounded on one side by a second vertical edge 32E, and a second channel 34 therebetween. A flat outer profile 32D of the jamb trim panel 30 extends from the first vertical edge 32C to the second vertical edge 32E. The first and second trim channels 32 and 34 improve the rigidity of the jamb trim panel 30. The first trim channel 32 also fills out the depression that is formed in conventional windows between the offset track profile 22 and the window frame 40 and provides the raised, but flat profile of the desired traditional wood-window-trim look. The first channel 32 is formed by an offset channel wall 32A, a flat channel wall 32B, the first vertical edge 32C, and a portion of the flat outer profile 32D. The J-channel connector 50A of the jamb trim panel 30 attaches or snaps into the mating J-channel connector 50B, such that the offset channel wall 32A abuts the offset track profile 22 of the screen track assembly 20 and the flat channel wall 32B fits up against a flat outer-wall surface 48A of the first box channel 48 of the window frame 40. The header trim panel 60 and sill trim panel 70 (shown in FIG. 1) similarly provide a profile that is raised relative to the window frame 40 and also flat, analogous to the profile of the jamb trim panel 30.

With continuing reference to FIG. 3, several seals are shown on the jamb trim panel 30 and on the window frame 40, by way of illustration. These seals provide a seal between one of the trim panels and the window frame 40 and/or the siding on the outer wall of the structure, to prevent the ingress of water into the wall. Two of the seals are barrier strips that are preferably made of rubber or a rubber-like synthetic material, such as a flexible PVC material. They may be co-extruded with or bonded to the trim panel, be it the header trim panel 60, the sill trim panel 70, or the jamb trim panel 30. A first barrier strip 54 is provided at the joint between the jamb trim panel 30 and the window frame 40. A second barrier strip 56 is provided in a siding channel 38 that is formed on the jamb trim panel 30 for receiving the ends of the wall siding. The siding channel 38 is formed by an inner trim panel extension 36 and the outer trim panel extension 37 and is dimensioned to accommodate vinyl siding of varying thicknesses, as well as to accommodate the thermal expansion of the run of vinyl siding. The ideal dimensions of the siding channel 38 in vinyl windows manufactured today are approximately 1 inch by 1 inch. When installing newer vinyl windows on structures with siding that is less than 1 inch thick, the siding channel 38 itself does not provide a close fit with the siding. The second barrier strip 56 is provided on the jamb trim panel 30 to provide an adaptable close fit and seal. This second barrier strip 56 is flexible enough to be deflected by thicker siding, yet strong enough to push thinner siding up against the wall of the structure. A third seal 58 is provided at the J-channel connection 50A/50B that attaches the jamb trim panel 30 to the window frame 40. A short seal-barrier 58A is formed on the rear surface of the J-channel 50B, forming a pocket 58B against the sidewall of the window frame 40. A formable sealant 58B is injected into the pocket 58B. This effectively seals this J-channel connection and prevents any moisture from being driven past the jamb trim panel 30 and window frame 40 into the wall.

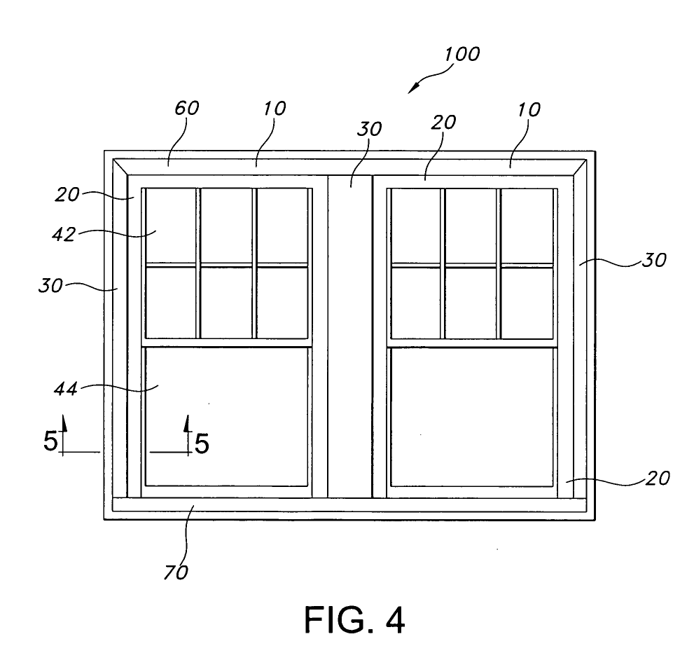

FIG. 4 is a front elevational view of a multiple window unit 100 showing two double hung window units 10 mulled together. A jamb trim panel 30, which, in this case, is known as a mullion trim panel, joins the individual windows to each other vertically. It is understood that the multiple window unit 100 may include any number of window units 10.

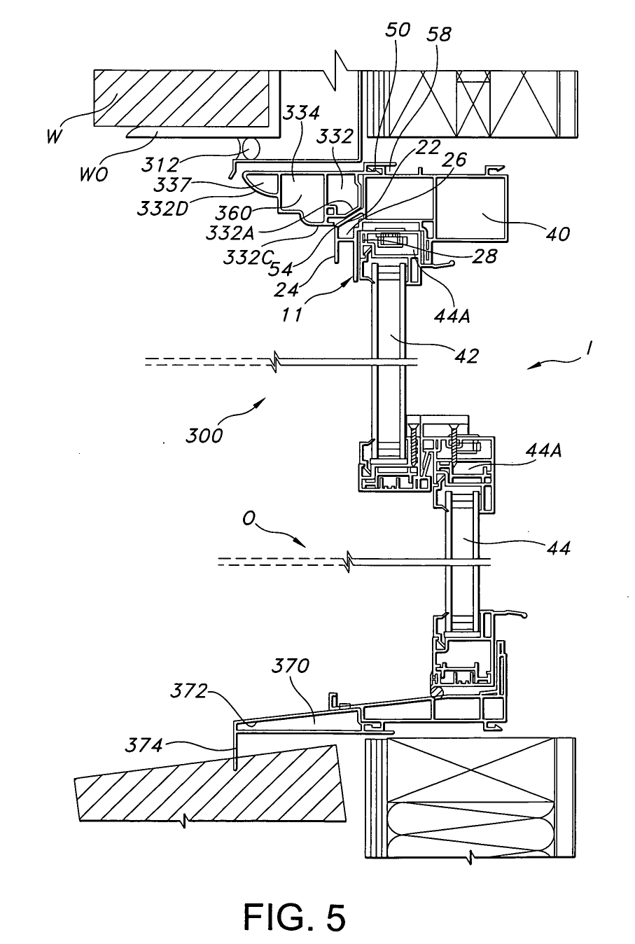

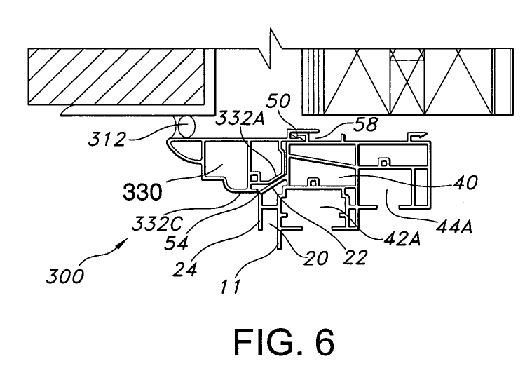

FIG. 5 is a side elevational view in cross-section of a deep-wall window unit 300, the cross-sectional cut being lengthwise through the window unit 300. The window frame 40 of the deep-wall window unit 300 is identical to that in the window unit 10 discussed above, but is trimmed with deep-wall trim panels that include: deep-wall jamb trim panels 330 (shown in FIG. 6), a deep-wall header panel 360 and a deep-wall sill panel 370. Each of these trim panels is analagous in function to the corresponding jamb trim panel 30, header trim panel 60, and the sill trim panel 70 described above. Structures with brick or stone walls typically have a thicker outer wall W than conventional wall construction with studs and siding. Because of this, the deep-wall window unit 300 is recessed farther from the outer surface of the outer wall W than with the conventional wall construction. The deep-wall window unit 300 has the same jamb trim panels 30 (mullion trim panels) between the individual windows. By contrast, the trim panels along the outer edges of the deep-wall window unit 300 do not extend out along the outer surface of the wall W, but remain instead recessed in a wall opening WO, as shown. The deep-wall trim panels 330/360/370 attach directly to the window frame 40 such that no valley is visually apparent between the screen track assembly 20 and the trim panels.

As can be seen in FIGS. 5 and 6, the trim panels 330 and 360 are analogous in profile and construction and it shall be understood that the description of the deep-wall trim panel 330 also applies to the header trim panel 360. The deep-wall jamb trim panel 330 includes a deep-wall first channel 332 with a deep-wall offset channel wall 332A, a deep-wall second channel 334 with a first vertical edge 332C, and a deep-wall trim extension panel 337. A deep-wall outer trim profile 332D extends from the first vertical edge 332C to the end of the deep-wall trim extension panel 337 and has a curved contour. The deep-wall header trim panel 360 and the deep-wall sill trim panel face outward and are curved in a decorative fashion. A seal 312 comprising flashing, backer rod and a barrier strip 314 is provided between the header trim panel 360 and the wall W. The deep-wall still trim panel 370 has a sill nose 372 that juts out over the sill block in the outer wall. An adaptable sill panel 374 supports the deep-wall sill trim panel on the sill block and is typically cut to length in the field to correspond to the slope of the sill block.

FIG. 6 is a cross-sectional view cut horizontally through the deep-wall window unit 300 at some location between the deep-wall header trim panel 360 and the deep-wall sill trim panel 370 and illustrates the deep-wall jamb trim panel 330. The deep-wall jamb trim panel 330 is attached to the window frame 40 in the same manner as the mullion trim panel 30 described above, with the same J-connection 50A/50B. The deep-wall offset channel wall 332A abuts the offset track profile 22 in the same manner. The same third seal 58 is provided to prevent water ingress into the wall. The deep-wall jamb trim panel 330 does not have the flat outer profile 32D, but rather, the curved deep-wall outer trim profile 332D. The key inventive feature of this deep-wall jamb trim panel 330 is that, like the jamb trim panel 30 described above, it provides a valleyless transition between the raised screen track assembly 20 and the trim panels 330/360/370.

Greater spacing between adjacent individual windows or a greater width of trim is aesthetically appealing and often requested. Also, for structural reasons, it may be desirable to have wider or narrower mullions between adjacent individual windows. The jamb trim panels 30 may be provided in a variety of widths with the J-channel connector 50A, so that they are readily interchangeably attachable to the vertical side edge of the window frame 40, making it a relatively simple matter to provide the desired spacing between windows.

Many window units today are made of extruded vinyl or other type of extruded plastic material. The window unit according to the invention may be constructed of such plastic or of other extruded materials.

Although specific embodiments of the window unit 10 and 300 are shown in FIGS. 3, 5, and 6, it is understood that the inventive feature does not reside in the specific construction of the window sashes, the channels for retaining the sashes, or the bug screen. The inventive feature, rather, lies in a window unit with a jamb trim panel that provides a “valleyless” outer profile, that is, in a jamb trim panel that attaches directly to or adjacent the bug screen in a manner that does not create a valley between the end of the bug screen and the beginning of the jamb trim panel.

It is understood that the embodiments described herein are merely illustrative of the present invention. Variations in the construction of the window unit may be contemplated by one skilled in the art without limiting the intended scope of the invention herein disclosed and as defined by the following claims.

What is claimed is:

1: A window unit for a double-hung window mountable in a wall, said window unit comprising:
a window frame that includes a screen track assembly that has an offset track profile that is offset in a plane parallel to an outside face plane of said window frame; and
a trim panel that attaches to said window frame so as to abut said screen track assembly, so as to provide a valleyless, outer profile between said screen track assembly and said trim panel.

2: The window unit of claim 1, wherein said trim panel is a jamb trim panel with a first vertical edge having a first wall section that is orthogonal to an outer flat jamb trim profile and a second wall section at an angle to said first wall section, wherein said offset track profile has an offset track wall that attaches to an outer flat track edge, and wherein said second wall section of said jamb trim panel abuts said offset track wall.

3: The window unit of claim 2, said jamb trim panel further comprising an outer open channel formed at a second vertical edge of said jamb trim panel, said outer open channel having an outer channel wall and an inner channel wall, wherein a barrier strip extends vertically along an inner surface of said outer channel wall and into said outer open channel.

4: The window unit of claim 1, wherein said trim panel is a header trim panel with a first horizontal edge having a first wall section that is orthogonal to an outer flat header trim profile and a second wall section at an angle to said first wall section, wherein said screen track assembly has an offset track wall that extends between said window frame and an outer flat track edge, and wherein said second wall section of said header trim panel abuts said offset track wall.

5: The window unit of claim 1, wherein said trim panel is a sill trim panel with a first horizontal edge having a first wall section that is orthogonal to an outer flat sill trim profile and a second wall section at an angle to said first wall section, wherein said screen track assembly has an offset track wall that extends between said window frame and an outer flat track edge, and wherein said second wall section of said sill trim panel abuts said offset track wall.

6: The window unit of claim 1, said trim panel further comprising an outer open channel formed at a second vertical edge of said trim panel, said outer open channel having an outer channel wall and an inner channel wall, wherein a barrier strip extends vertically along an inner surface of said outer channel wall and into said outer open channel.

7: The window unit of claim 1, said trim panel having a first J-channel connector that connects at a rear surface to a second J-channel connector on said window frame, wherein a seal-barrier is formed on said rear surface of said first J-channel to form a pocket that extends along a joint between said window frame and said jamb trim panel, and wherein said pocket is adapted to receive a sealant.

8: A window unit for a double-hung window mountable in a wall, said window unit comprising:
a window frame that includes a flat outer frame surface and a screen track assembly that has a flat track profile with an outer flat track edge and a sloping track profile that extends between said outer flat track edge and said flat outer frame surface; and
a trim panel that attaches to said window frame, said trim panel having a first edge proximal to said window frame, a second edge distal to said window frame, with a flat trim panel profile therebetween, an inner trim panel wall, and a sloping inner trim panel wall that extends between said first edge and said inner trim panel wall;
wherein, when said window frame and said trim panel are assembled in said wall, said sloping inner trim panel wall and said inner trim panel wall of said trim panel fit up against said sloping track profile of said screen track assembly and said wall, respectively, such that said flat trim panel profile and said flat track profile together provide a valleyless outer profile of said window frame and said trim panel.

9: The window unit of claim 8, said trim panel further comprising an outer open channel formed at said second vertical edge of said trim panel, said outer open channel having an outer channel wall and an inner channel wall, wherein a barrier strip extends vertically along an inner surface of said outer channel wall and into said outer open channel.

10: The window unit of claim 8, said trim panel having a first J-channel connector that connects at a rear surface to a second J-channel connector on said window frame, wherein a seal-barrier is formed on said rear surface of said first J-channel to form a pocket that extends along a joint between said window frame and said jamb trim panel, and wherein said pocket is adapted to receive a sealant.

11: A window unit for a double-hung window mountable in a recess between recess walls, said window unit comprising:
a window frame that has an outside face plane and that includes a screen track assembly that has a flat track profile formed by an outer flat track edge and a sloping track profile which extends between said outer flat track edge and said outside face plane; and
a trim panel that attaches to said window frame, said trim panel having a first edge proximal to said window frame, a second edge distal to said window frame and mountable against one of said recess walls, with a trim panel profile therebetween, an inner trim panel wall, and a sloping inner trim panel wall that extends between said first edge and said inner trim panel wall;
wherein, when said window frame and said trim panel are assembled in said recess, said sloping inner trim panel wall fits up against said sloping track profile of said screen track assembly and said inner trim panel wall of said trim panel fits up against said outer face plane, such that said trim panel and said flat track profile together provide a valleyless transition from said flat track profile to said trim panel profile.

12: The window unit of claim 11, said trim panel further comprising an outer open channel formed at said second vertical edge of said trim panel, said outer open channel having an outer channel wall and an inner channel wall, wherein a barrier strip extends vertically along an inner surface of said outer channel wall and into said outer open channel.

13: The window unit of claim 11, said trim panel having a first J-channel connector that connects at a rear surface to a second J-channel connector on said window frame, wherein a seal-barrier is formed on said rear surface of said first J-channel to form a pocket that extends along a joint between said window frame and said jamb trim panel, and wherein said pocket is adapted to receive a sealant.
